(19) United States
(12) Patent Application Publication
(10) Pub. No.: US 2018/0221751 A1
(43) Pub. Date: Aug. 9, 2018

(54) Electromagnetic Radiation Activated Athletic Timers

(71) Applicant: Ryan Samuel Turner, North Chelmsford, MA (US)

(72) Inventor: Ryan Samuel Turner, North Chelmsford, MA (US)

(21) Appl. No.: 15/820,347

(22) Filed: Nov. 21, 2017

Related U.S. Application Data
(60) Provisional application No. 62/456,935, filed on Feb. 9, 2017.

(51) Int. Cl. A63B 71/06; G07C 1/22

(52) U.S. Cl. CPC A63B 71/0686; A63B 2220/89; G07C 1/22

(57) ABSTRACT

Systems, devices, and methods of gateless timekeeping systems for athletic endeavors. Gateless detection devices that emit and detect EM radiation to determine whether an athlete or object has crossed the device's threshold. Systems of multiple gateless detection devices that can be used to measure sprint times and speeds between two points, where the devices are communicatively coupled with one another via wireless connection to coordinate timekeeping.

This application claims priority to application Ser. No. 62/456,935, filed Feb. 9, 2017. All extrinsic materials identified in this application are incorporated by reference in their entirety.

### FIELD OF THE INVENTION

The field of the invention is automatic athletic timers.

### BACKGROUND

The background description includes information that may be useful in understanding the present invention. It is not an admission that any of the information provided in this application is prior art or relevant to the presently claimed invention, or that any publication specifically or implicitly referenced is prior art.

Automated timing devices for athletic events (i.e., devices that detect when an athlete crosses a threshold such as a start or finish line) have traditionally required devices that come in pairs to create a “gate.” When an athlete passes through a gate, an event is recorded, which can be correlated to a timer. The ultimate goal is to record, for example, lap times or sprint times in various athletic activities.

In many of these systems, one device emits a signal, and another device receives that signal, where one device is placed opposite the other to create a “gate” as described above. When a “break” in the signal is detected—for example, when an athlete passes between the gate—a time is recorded. These systems fail to appreciate that the same outcome can be achieved without the need to create a “gate.”

All extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

Thus, there is still a need in the art for gateless athletic timers.

### SUMMARY OF THE INVENTION

The present invention provides apparatuses, systems, and methods of a gateless athletic timing system. In one aspect of the inventive subject matter, a gateless athletic activity timing device is contemplated. It includes: a housing; an electromagnetic radiation emitter and an electromagnetic radiation detector, each disposed within the housing, where the electromagnetic radiation emitter is configured to emit radiation to reflect off one or more surfaces, and the electromagnetic radiation detector is configured to detect the reflected radiation; a display coupled with the housing; a computing device disposed within the housing, the computing device communicatively coupled with the electromagnetic radiation emitter, the electromagnetic radiation detector, and the display, where the electromagnetic radiation detector is configured to transmit a signal to the computing device indicating that reflected electromagnetic radiation has been detected; and a timer operated by the computing device, where the timer is configured to start, stop, or record data based on the signal from the electromagnetic radiation detector.

In some embodiments, a device can include a communication module disposed within the housing, where the computing device is communicatively coupled with the communication module.

In some embodiments, a device can be held up by a stand, where the housing is coupled with the stand such that the housing is elevated above the ground by the stand. The stand can include a tilting component and a swiveling component, thereby coupling the stand to the housing.

The electromagnetic radiation emitter can emit electromagnetic radiation in a beam configuration or a laser configuration. It is contemplated that the electromagnetic radiation emitter can emit electromagnetic radiation in a pattern, a non-periodic form, and an encoded signal. In some embodiments, the electromagnetic radiation emitter includes the electromagnetic radiation detector.

In another aspect of the inventive subject matter, a system for gatelessly detecting and measuring athletic activity timing between two points is contemplated. The system includes a first and second device. The first device includes: a first housing; a first electromagnetic radiation emitter and a first electromagnetic radiation detector, each disposed within the first housing, where the first electromagnetic radiation emitter is configured to emit a first electromagnetic radiation to reflect off at least one surface, and the first electromagnetic radiation detector is configured to detect the first electromagnetic radiation reflected off the at least one surface, and the first electromagnetic radiation detector is configured to transmit a first signal to the first computing device indicating that the first electromagnetic radiation reflection has been detected; a first communication module disposed within the first housing; and a first computing device disposed within the first housing and communicatively coupled with the first electromagnetic radiation emitter, the first electromagnetic radiation detector, and the first communication module.

The second device includes: a second housing; a second electromagnetic radiation emitter and a second electromagnetic radiation detector, each disposed within the second housing, wherein the second electromagnetic radiation emitter is configured to emit a second electromagnetic radiation to reflect off the at least one surface, and the second electromagnetic radiation detector is configured to detect the second electromagnetic radiation reflected off the at least one surface; a display coupled with the second housing; a second communication module configured, at least, to receive a communication signal from the first communication device; a second computing device disposed within the second housing, the second computing device communicatively coupled with the second electromagnetic radiation emitter, the second electromagnetic radiation detector, the second communication module, and the display, where the second electromagnetic radiation detector is configured to transmit a second signal to the second computing device indicating that the second electromagnetic radiation reflection has been detected; and a timer operated by the second computing device, where the timer is configured to start, stop, or record data based on the second signal from the second electromagnetic radiation detector.

In some embodiments, the first and second electromagnetic radiation emitters are configured to emit infrared light, and the first and second electromagnetic detectors are configured to detect infrared light. The first electromagnetic radiation emitter can include the first electromagnetic radiation detector, and the second electromagnetic radiation emitter can include the second electromagnetic radiation detector.

It is contemplated that the first and second electromagnetic radiation emitters can emit electromagnetic radiation in a beam configuration or in a laser configuration. The first and second electromagnetic radiation emitters can emit electromagnetic radiation in a pattern, a non-periodic form, or an encoded signal.

It is contemplated that the communication signal from a first communication device to a second communication device is based on at least one of the first signal and the second signal.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows a schematic of a device of the inventive subject matter.

FIG. 2 shows a flow chart of the functions of an embodiment of a single-device system.

FIG. 3 illustrates an embodiment of a device with an object passing in front of it.

FIG. 4 shows a flow chart of the functions of an embodiment of a multi-device system.

FIG. 5 illustrates an embodiment of a multi-device system with an object passing in front of the devices.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, wavelength ranges, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

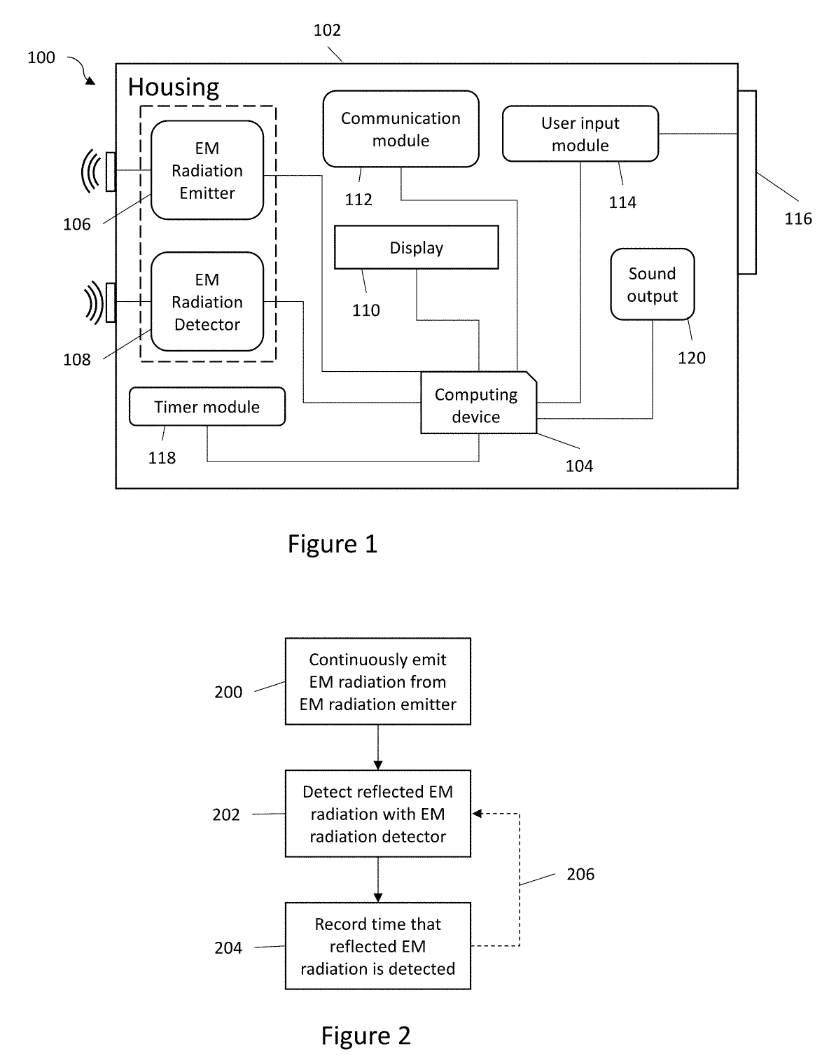

FIG. 1 shows an embodiment of a device 100 of the inventive subject matter. Device 100 includes a housing 102 that holds the various internal components, including: a computing device 104, an electromagnetic (EM) radiation emitter 106, an EM radiation detector 108, a display 110, a communication module 112, a user input module 114, an input component 116, a timer module 118, and a sound output 120.

Every device of the inventive subject matter includes a computing device 104, though complexity and capability of the computing device 104 depends on the requirements of a particular embodiment. For example, some embodiments include every single one of the components shown in FIG. 1, which would require a computing device with sufficient I/O and processing capabilities to operate all of the various components. In other embodiments, for example, there may not be a need for a timer module 118 or a communication module 112—in those embodiments, the computing device 104 would not need to be as capable (e.g., it may not require as much I/O support).

It is contemplated that several of the modules shown in FIG. 1 can be integrated into the computing device 104, while in other embodiments, the modules are physically separate (despite all being shown as separate in FIG. 1). For example, the communication module 112, the input module 114, and the timer module 118 can be integrated into the computing device 104 (e.g., in software or in specialized hardware that is integrated into the circuitry of the computing device 104).

The EM radiation emitter 106 and EM radiation detector 108, for example, can be integrated into a single component as demonstrated by the dotted line around the components in FIG. 1. Although this application describes both the emitter and detector as operating using EM radiation, it is also contemplated that a sound-based system can be implemented.

On the spectrum of EM radiation, infrared radiation is contemplated. In other embodiments, the EM emitter and detector can operate using visible light, UV light, or any other wavelength of EM radiation (alone or in combination with other wavelengths of EM radiation) that is not considered harmful to humans in small amounts (e.g., amounts required for operation of devices of the inventive subject matter).

An emission from the EM radiation emitter 106 can be continuous (e.g., “on” in a binary system where the state can be “on” or “off”). In some embodiments, the EM radiation emitter 106 generates an emission that includes an identifiable signal. The identifiable signal can be emitted continuously, or periodically (e.g., at regular or irregular intervals). In the context of this application, any EM radiation emission can be considered a “signal,” although some signals are more complex than a simple “on” condition for emission.

A signal can be made identifiable by the EM radiation emitter in a variety of ways, but the overarching goal of making an identifiable signal is to reduce the risk of “false positives” by ensuring that the EM radiation detector of a particular device is more likely to detect an emission from that same device's EM radiation emitter, than to detect an errant emission from another device or from any other source.

In some embodiments, identifiable signals can be patterned. For example, the on-board computer in a device can be configured to cause the EM radiation emitter to output EM radiation in a repeating pattern. The on-board computer would then be further configured to register a reflection only when the EM radiation detector picks up a reflection of that repeating pattern.

In some embodiments, the signal can be randomized. A randomized signal can be repeated periodically, while in other embodiments, a randomized signal is non-repeating (similar to an irrational number).

In embodiments where EM radiation is emitted in the form of an identifiable signal, it is contemplated that the form (e.g., a digitized version) of some amount of that identifiable signal that is emitted by an EM radiation emitter is stored to computer memory (e.g., 0.01-10 ms or 10-100 ms of the most recently emitted signal). Thus, when the EM detector detects reflected EM radiation, the computing device can determine whether that reflected EM radiation originated from the device housing that computing device by comparing the reflected signal to the signal stored in memory corresponding to the emitted signal. This helps ensure that each device of the inventive subject matter registers reflections only when a reflection corresponds to the emitted signal originating from that same device, which safeguards against false positives that can be caused by noise (e.g., EM radiation that originates from some other source).

It is additionally contemplated that a signal can be emitted as a focused cone or beam using a lens or system of lenses (e.g., an EM emission that has a narrower cone of projection from the EM emitter than it would naturally have). A signal can additionally or alternatively be emitted as a laser. Beams, cones, and lasers can be implemented to improve the ability of a device to detect more precisely when an object passes in front of it (e.g., by narrowing the area of reflection to an area more directly in front of the device rather than a wider cone in front of a device). In embodiments where an EM emission is projected as a cone, the apex angle of the cone can be adjusted via input to the device.

It is contemplated that EM detectors can additionally be configured to register a reflected signal detection only when the signal intensity rises above a threshold. For example, if an EM radiation signal is emitted at 100% intensity, it is contemplated that a reflection is detected only when the reflected signal is detected at 99-90%, 90-80%, 80-70%, 70-60%, 60-50%, 50-40%, 30-20%, 20-10%, and 10-1%. The desired threshold percent is based on a variety of factors including, for example, an athlete's anticipated proximity to a device when crossing in front of it.

In embodiments with a sound-based emitter and detector, a sound is emitted from a sound emitter, and the sound detector detects a reflected sound after it bounces off of an object. It is contemplated that the emitted, similar to embodiments operating using EM radiation. As described above with respect to EM radiation, a sonic emission can include an identifiable signal, and the sonic emission can also be emitted as a cone having different apex angles or even in a beam-like configuration. All of the discussion above with respect to EM radiation can apply to sonic emissions and detections, insofar as physics allows.

In some embodiments, the EM radiation emitter and detector can be integrated into a Position Sensing Device (PSD) (e.g., in embodiments where the EM emitter 106 and EM detector 108 are integrated into a single component, that single component can be a PSD). Broadly speaking, a PSD receives a reflected signal and can determine an object's position using that reflected signal. Thus, in embodiments using a PSD, the PSD itself is implemented to ensure a reflection is registered by the device when an object passes in front of the device. This improves the ability of the device to accurately measure a time between, for example, two distances or a time between laps.

Embodiments of the inventive subject matter can also include a display 110. A display 110 can be configured to show basic information to, for example, facilitate user input into a device. For example, a display 110 can show lap times, split times, speed, menus, and so on.

Some embodiments also include a user input module 114, which processes inputs from a user. User inputs can originate from an input component 116 (e.g., buttons, either physical or touch-sensitive virtual buttons) that receives input directly to the device, and, in some embodiments, the input module 114 can receive inputs wirelessly from a remote device (e.g., a user's computer or mobile device). It is contemplated that, in some embodiments, the input component 116 can be a touchscreen, where that touch screen can be a standalone input unit, or it can be integrated with the display 110. Both remote input and direct input into devices of the inventive subject matter are contemplated.

The communication module 112 can be used to communicate with other devices of the inventive subject matter, but it can also be used (as mentioned above) to facilitate communication with other computing devices (e.g., cell phones, computers, etc.) The communication module 112 can be capable of, for example, Bluetooth, WiFi, IR, or any other communication protocol known in the art. It is also contemplated that the communication module can facilitate wired communication (e.g., a wireless unit that also has a wired connection, or a module that is capable only of wired communication). The communication module 112 can include an I/O port to facilitate connection of other devices of the inventive subject matter, or to receive input from a user via remote input (e.g., wired or wireless input).

Devices of the inventive subject matter can additionally include a timer module 118. The time module 118 can be a dedicated component within the device to operate timer functions, but it is also contemplated that the timer module 118 can be a virtual module operated by the computing device 104. The timer module receives signals via the computing device, which determines when to start and stop a timer.

The timer can be used to measure both time and speed. For example, when a device or system of devices are used to measure a time traveled across a known distance, average speed can be computed by dividing distance by time.

Each module and component in the device 100 shown in FIG. 1 is communicatively coupled with the computing device 104, which can use information from each module and component to operate the device 100. When two items are “communicatively coupled” it means that electrical signal can be transmitted either in one direction or both directions between the items (e.g., devices, modules, components, etc.).

The sound output 120, as shown in FIG. 1, can be used by devices of the inventive subject matter to project sounds to users. For example, a sound can alert a user that an object has passed in front of the device sufficient to trigger a reflection that has been detected by the device. The sound output 120, in some embodiments, can read out lap times or split times so that a runner can know how fast they are completing laps or running a distance. In some embodiments, the sound output can do a countdown to a start time, which corresponds to the starting of a timer. It is contemplated that the sound output 120 can be a small speaker or other device capable of causing vibration sufficient to create audible sound waves.

Devices of the inventive subject matter can be powered by electricity, either by battery or by plugging a device in to a fixed power source (e.g., a 110V or 220V power outlet).

FIG. 2 is a flow chart describing the basic functions of a device of the inventive subject matter. As described in step 200, the device first continuously emits EM radiation from its EM radiation emitter. Emission of EM radiation (e.g., in the form of a signal) is accomplished according to the discussion above. As described in step 202, the device, using its EM radiation detector, listens for a reflection of the emitted signal. When a reflection of that signal is detected, the device, using its onboard computer, records the time that the reflection is detected, as described in step 204. The time that the reflection is detected can be the actual time (i.e., the time of day), or it can be a relative time (e.g., starting at 0 seconds and counting from that start point for each subsequent reflection detection).

It is contemplated that a start time can be recorded by manual input via input module or communication module. For example, a start time can begin with a button push by a coach or athlete using a device of the inventive subject matter.

It is contemplated that time recordation is handled by the timer module, which, as described above, can be software stored on the computing device, or a separate component. Thus, when time recordation “by the computing device” is described in this application, it should be understood to mean that the computing device records time in association with the timer module, whether the timer module is physical or software-based.

As shown by dotted line 206, steps 202 and 204 can be repeated. For example, if a device is set up at a start/finish line for a lap, it can be used to record lap times and splits by listening for subsequent EM radiation signal reflections, where each subsequent signal reflection after the first signifies completion of a lap.

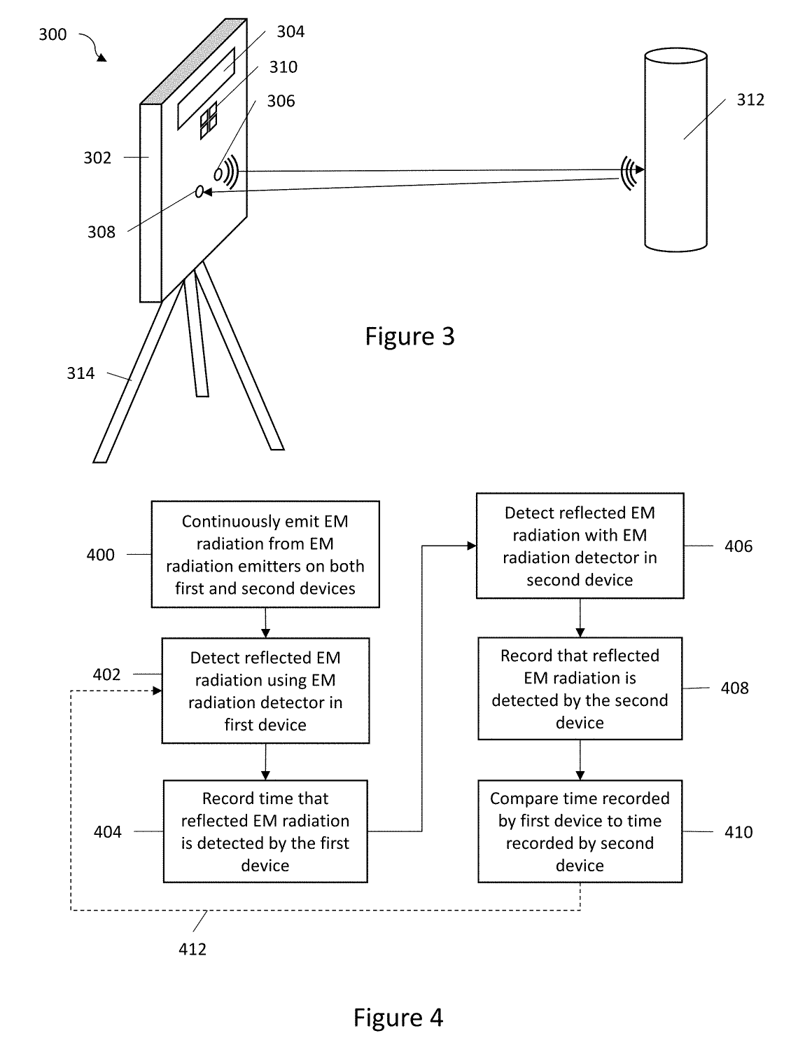

An embodiment of the device 300 is shown in FIG. 3. It shows a housing 302, a display 304, an EM radiation emitter 306, an EM radiation detector 308, an input device 310, and it also shows an object 312 that causes signal from the EM radiation emitter 306 to reflect back to the EM radiation detector 308. The housing 302 holds all of the modules and components present in any particular embodiment of the device, which can include all, or some subset of, the components and modules described in FIG. 1 and not otherwise pictured in FIG. 3 (e.g. a communication module, a timer module).

The device 300 in FIG. 3 also shows a stand 314 that is used to hold the device 300 above the ground. This can be advantageous to improve the device's ability to reflect a signal off an object 312 (e.g., a human body).

In one example use of a device of the inventive subject matter, a user could use the device to measure lap times. To do so, a user would set the device up at a starting/finishing line. Once set up, the device must then begin operation (as described in FIG. 2), whereby it begins to emit EM radiation and begins listening for EM radiation reflections. The user then begins to run laps, where timing of the first lap is begun, for example, when the user first passes in front of the device, causing the EM radiation signal that is emitted from the EM radiation emitter to reflect back to the EM radiation detector, or by a manual initiation of the device.

It is also contemplated that two or more devices of the inventive subject matter can operate together. For example, FIG. 4 describes a system of the inventive subject matter that includes two devices. As described in step 400, use of the system begins with both of the devices continuously emitting EM radiation from their EM radiation emitters. Emission of EM radiation can be carried out as described above (e.g., by emitting a signal). Next, as described in step 402, when an object passes in front of a first device causing a reflection of the emitted EM radiation, the EM radiation detector in that device detects the reflected EM radiation.

Next, as described in step 404, a time is recorded by the first device according to when the EM radiation detector in the first device detects a reflected EM radiation emission that is emitted by the first device. Once the first device has detected a reflection and recorded a time, the second device then does the same, as described in steps 406 and 408. When the second device detects a reflected EM radiation emission that was emitted by the second device (step 406), it then records a time (step 408). In a final step 410, a time recorded by the first device and a time recorded by the second device are compared. This comparison can yield, for example, an elapsed time, a lap time, a split time, and a speed.

Devices as described in FIG. 4 can be communicatively coupled with one another either by a wired connection or wirelessly via a communication module present in all devices. Information collected by each device can then be shared with the other by this communicative coupling.

In multi-device systems, each device can have a common clock to facilitate timing. The common clock can be operated within software running on the computing device, or it can be operated within the timer module itself in embodiments where the timer module is a component separate from the computing device. In some embodiments, both the first and the second device are communicatively coupled with each other by communications modules that are contained within each device (as shown in FIG. 1), where that communicative coupling between devices allows the devices to sync clocks to ensure the timer module (e.g., either in one or both of the devices) operates correctly using signals from both devices.

In some embodiments, clocks in the first and second devices begin at the same time (e.g., in an absolute clock system). This can simplify calculations necessary to determine lap times and the like. For example, it can be possible for either device to do a simple mathematical operation to determine time elapsed between EM radiation emission reflection detections at the different devices (e.g., by subtraction of a first recorded time from a second recorded time). Comparison of recorded times is described in step 410.

Step 410 can also be accomplished in embodiments of the system where only one of several devices keeps time (e.g., in embodiments where only one of several devices has a timer module). For example, if the first device is the only one keeping time, then when the second device detects a reflected EM radiation that the second device emitted, it would send a signal (e.g., via a communication module) to the first device immediately upon detection. Then, when the first device receives the signal from the second device alerting the first device to the fact of a detected reflected EM radiation at the second device, the first device would record the time it received that signal relative to the time that it detected its own EM radiation reflection. With a time recorded for the reflection detected by the first device, and a time recorded corresponding to the reflection detected by the second device, the first device can then compare those times to determine how much time passed between the triggering of each device by reflected EM radiation signals. This information can be used to determine, for example, an elapsed time, a lap time, a split time, and a speed.

Dotted line 412 shows that the process can repeat steps 402 through 410. This can facilitate laps with splits. For example, if a first device is placed on a one mile loop at the start/finish, and the second device is at the half-mile marker, half mile splits could be computed along with mile times.

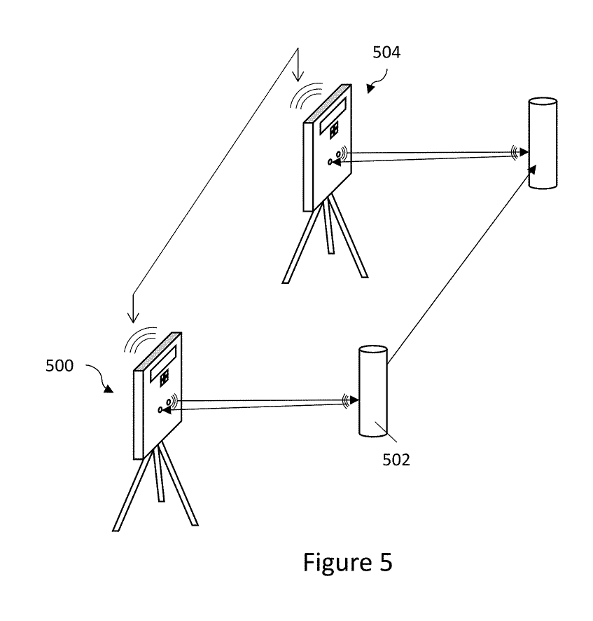

Just as with a single device embodiment, each device in a multi-device embodiment is essentially operating independently from the other while cooperating wirelessly. An embodiment of a multi-device system is shown in FIG. 5. The first device 500 detects a reflected EM radiation emission that originates from the first device 500 (as shown by the arrows pointing from the first device 500 to a passing object 502 and back), and the second device 504 detects a reflected EM radiation emission that originates from the second device 504 and reflects off of the same object 502 when it passes in front of the second device 504 (though the object does not need to be the same one, in many use cases, it would be the same object, e.g., a runner on a track). In multi-device embodiments, using different signals (described in more detail above) for each device can prevent false positives that could occur if, for example, the second device detects a reflected EM radiation emission that originated from the first device.

It is also contemplated that one or more of the several devices can include fewer components. One way to describe this is as having a master and slave device, where the master device includes all of the necessary internal components to operate independently, and the slave device includes only those components necessary to operate in conjunction with the master device (e.g., a computing device, an EM radiation emitter, an EM radiation detector, and a communication module).

It is contemplated that either device can operate as the “first device” as described above. That is, either of the two devices can be the time keeper with the other device acting only as a reflection detector with the ability to transmit a signal to one or more companion devices of the inventive subject matter.

Thus, specific systems, methods, and apparatuses of athletic time keeping devices have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A gateless athletic activity timing device comprising:
a housing;
an electromagnetic radiation emitter and an electromagnetic radiation detector, each disposed within the housing, wherein the electromagnetic radiation emitter is configured to emit radiation to reflect off one or more surfaces, and the electromagnetic radiation detector is configured to detect the reflected radiation;
a display coupled with the housing;
a computing device disposed within the housing, the computing device communicatively coupled with the electromagnetic radiation emitter, the electromagnetic radiation detector, and the display;
wherein the electromagnetic radiation detector is configured to transmit a signal to the computing device indicating that reflected electromagnetic radiation has been detected; and
a timer operated by the computing device, wherein the timer is configured to start, stop, or record data based on the signal from the electromagnetic radiation detector.

2. The device of claim 1, further comprising a communication module disposed within the housing, wherein the computing device is further communicatively coupled with the communication module.

3. The device of claim 1, further comprising a stand, wherein the housing is coupled with the stand such that the housing is elevated above the ground by the stand.

4. The device of claim 3, wherein the stand comprises at least one of a tilting component and a swiveling component, thereby coupling the stand to the housing.

5. The device of claim 1, wherein the electromagnetic radiation emitter emits electromagnetic radiations in a beam configuration.

6. The device of claim 1, wherein the electromagnetic radiation emitter emits electromagnetic radiations as a laser.

7. The device of claim 1, wherein the electromagnetic radiation emitter emits electromagnetic radiation in at least one of a pattern, a non-periodic form, and an encoded signal.

8. The device of claim 1, wherein the electromagnetic radiation emitter comprises the electromagnetic radiation detector.

9. The device of claim 1, wherein the EM radiation emitter and EM radiation detector are part of a Position Sensing Device.

10. A system for gatelessly detecting and measuring athletic activity timing between two points comprising:
a first device comprising:
a first housing;
a first electromagnetic radiation emitter and a first electromagnetic radiation detector, each disposed within the first housing, wherein the first electromagnetic radiation emitter is configured to emit a first electromagnetic radiation to reflect off at least one surface, and the first electromagnetic radiation detector is configured to detect the first electromagnetic radiation reflected off the at least one surface;
wherein the first electromagnetic radiation detector is configured to transmit a first signal to the first computing device indicating that the first electromagnetic radiation reflection has been detected;
a first communication module disposed within the first housing; and
a first computing device disposed within the first housing and communicatively coupled with the first electromagnetic radiation emitter, the first electromagnetic radiation detector, and the first communication module;
a second device comprising:
a second housing;
a second electromagnetic radiation emitter and a second electromagnetic radiation detector, each disposed within the second housing, wherein the second electromagnetic radiation emitter is configured to emit a second electromagnetic radiation to reflect off the at least one surface, and the second electromagnetic radiation detector is configured to detect the second electromagnetic radiation reflected off the at least one surface;
a display coupled with the second housing;
a second communication module configured, at least, to receive a communication signal from the first communication device;
a second computing device disposed within the second housing, the second computing device communicatively coupled with the second electromagnetic radiation emitter, the second electromagnetic radiation detector, the second communication module, and the display;
wherein the second electromagnetic radiation detector is configured to transmit a second signal to the second computing device indicating that the second electromagnetic radiation reflection has been detected; and
a timer operated by the second computing device, wherein the timer is configured to start, stop, or record data based on the second signal from the second electromagnetic radiation detector.

11. The system of claim 10, wherein the first and second electromagnetic radiation emitters are configured to emit infrared light, and wherein the first and second electromagnetic detectors are configured to detect infrared light.

12. The system of claim 10, wherein the first electromagnetic radiation emitter comprises the first electromagnetic radiation detector, and wherein the second electromagnetic radiation emitter comprises the second electromagnetic radiation detector.

13. The system of claim 10, wherein the first and second electromagnetic radiation emitters emit electromagnetic radiation in a beam configuration.

14. The system of claim 10, wherein the first and second electromagnetic radiation emitters emit electromagnetic radiation as a laser.

15. The system of claim 10, wherein the first and second electromagnetic radiation emitters emit electromagnetic radiation in at least one of a pattern, a non-periodic form, and an encoded signal.

16. The system of claim 10, wherein the communication signal is based on at least one of the first signal and the second signal.

17. The system of claim 10, wherein the EM radiation emitter and EM radiation detector are part of a Position Sensing Device.
